(19) United States
(12) Patent Application Publication
(10) Pub. No.: US 2018/0017417 A1
(43) Pub. Date: Jan. 18, 2018

(54) SYSTEM AND METHOD FOR IDENTIFYING AND PREDICTING FAULTS IN SENSORS OF LOCOMOTIVES

(71) Applicant: Electro-Motive Diesel, Inc., LaGrange, IL (US)

(72) Inventor: David P. Kickham, Munster, IN (US)

(73) Assignee: Electro-Motive Diesel, Inc., LaGrange, IL (US)

(21) Appl. No.: 15/209,264

(22) Filed: Jul. 13, 2016

(51) Int. Cl. G01D 18/00; B61L 23/00; B61K 9/00

(52) U.S. Cl. CPC G01D 18/00; B61K 9/00; B61L 23/00

(57) ABSTRACT

A system for identifying a fault in sensors disposed in two or more locomotives of a consist is disclosed. The system includes a first sensor, disposed in a first locomotive, configured to detect a first value of a parameter associated with operation of the first locomotive. The system includes a second sensor, disposed in a second locomotive, configured to detect a second value of the parameter associated with operation of the second locomotive. The system includes a receiving unit, in communication with the first sensor and the second sensor, configured to receive the first value and the second value of the parameter. The system includes a controller configured to compare the first value with the second value of the parameter, and identify the fault in one of the first sensor and the second sensor based on the comparison between the first value and the second value.

### TECHNICAL FIELD

The present disclosure relates to identification and prediction of faults in sensors, and more particularly to a system and methods for identification and prediction of faults in the sensors of locomotives of a consist.

### BACKGROUND

A train usually includes locomotives with a power source, and rail cars driven by the locomotives. A plurality of locomotives that is physically connected by a Multiple Unit (MU) cable is known as a consist. In each locomotive, one or more sensors are disposed for detecting values of parameters associated with operation of the locomotive. The values as detected by the sensors may be utilized for controlling an overall operation of the locomotives and in turn, of the train. In case of failure of any of the sensors, the operation of the train is hampered, and safety of passengers may also be compromised. Currently, it is difficult to detect or predict failure of the sensors disposed in the locomotives.

U.S. Pat. No. 8,922,385 (the '385 patent) discloses a vehicle coupling fault detecting system. The system may include first and second selectively-pressurized fluid conduits containing first and second communication cables that are communicatively coupled when the first and second fluid conduits are connected together. A pressure sensor may detect a pressure within the fluid conduits when the conduits are connected together, and communicate a signal indicative of the pressure through at least one of the first and second communication cables. A controller may receive the signal and determine from the signal whether there is a fault in the connection between the first and second selectively-pressurized fluid conduits. However, the system of the '385 patent offers a complicated, fragmented, and a relatively inaccurate approach for detecting a fault in a coupling of a consist.

### SUMMARY OF THE DISCLOSURE

In one aspect of the present disclosure, a system for identifying a fault in sensors disposed in two or more locomotives of a consist is provided. The system includes a first sensor, disposed in a first locomotive, configured to detect a first value of a parameter associated with operation of the first locomotive. The system further includes a second sensor configured to detect a second value of the parameter associated with operation of a second locomotive. The second sensor is disposed in the second locomotive which is in communication with the first locomotive. The system further includes a receiving unit, in communication with the first sensor and the second sensor, configured to receive the first value and the second value of the parameter from the first sensor and the second sensor respectively. The system further includes a controller which is in communication with the receiving unit. The controller is configured to compare the first value with the second value of the parameter, and identify the fault in one of the first sensor and the second sensor based on the comparison between the first value and the second value.

In another aspect of the present disclosure, a method for identifying a fault in sensors disposed in two or more locomotives of a consist is provided. The method includes receiving, from a first sensor, a first value of a parameter associated with operation of a first locomotive. The method further includes receiving, from a second sensor, a second value of the parameter associated with operation of a second locomotive. The method further includes comparing the first value with the second value of the parameter. The method further includes identifying the fault in at least one of the first sensor and the second sensor based on the comparison between the first value and the second value.

In yet another aspect of the present disclosure, a method for predicting a fault in sensors disposed in two or more locomotives of a consist is provided. The method includes receiving, from a first sensor, a first value of a parameter associated with operation of a first locomotive. The method further includes receiving, from a second sensor, a second value of the parameter associated with operation of a second locomotive. The method further includes monitoring the first value and the second value received from the first sensor and the second sensor respectively, for a predefined time duration. The method further includes identifying a pattern of the first value and the second value of the parameter over the predefined time duration. The method further includes predicting the fault in at least one of the first sensor and the second sensor based on the pattern of the first value and the second value.

Other features and aspects of this disclosure will be apparent from the following description and the accompanying drawings.

### BRIEF DESCRIPTION OF THE DRAWINGS

FIG. 1 is a schematic view of a train having multiple locomotives of a consist in communication with a system, according to one embodiment of the present disclosure;

FIG. 2 is a block diagram of the system for identifying and predicting a fault in sensors disposed in the multiple locomotives, according to one embodiment of the present disclosure;

FIG. 3 is a block diagram of a controller of the system, according to one embodiment of the present disclosure;

FIG. 4 is a block diagram of the multiple locomotives in communication with the system, according to another embodiment of the present disclosure;

FIG. 5 is a flowchart of a method for identifying a fault in sensors disposed in two or more locomotives of a consist, according to one embodiment of the present disclosure; and

FIG. 6 is a flowchart of a method for predicting the fault in sensors disposed in the two or more locomotives of the consist, according to one embodiment of the present disclosure.

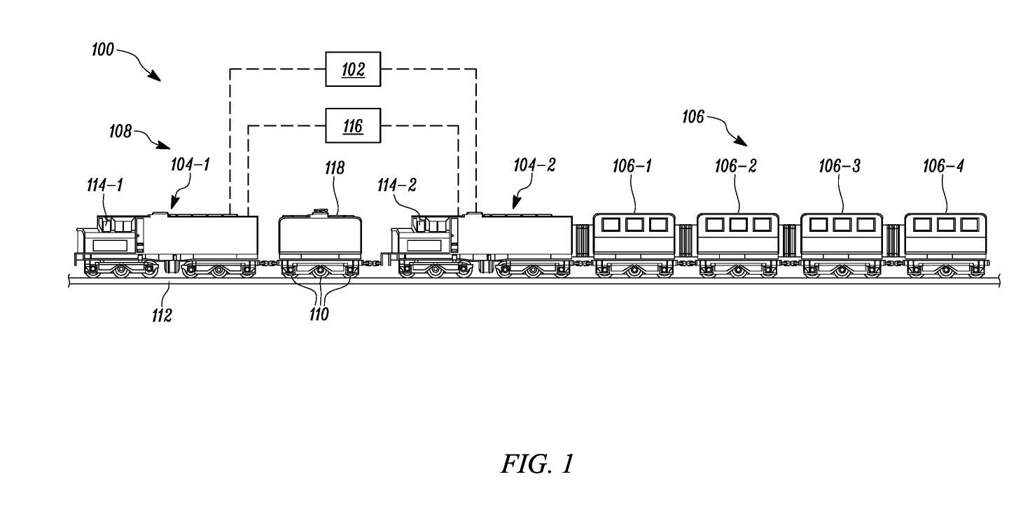

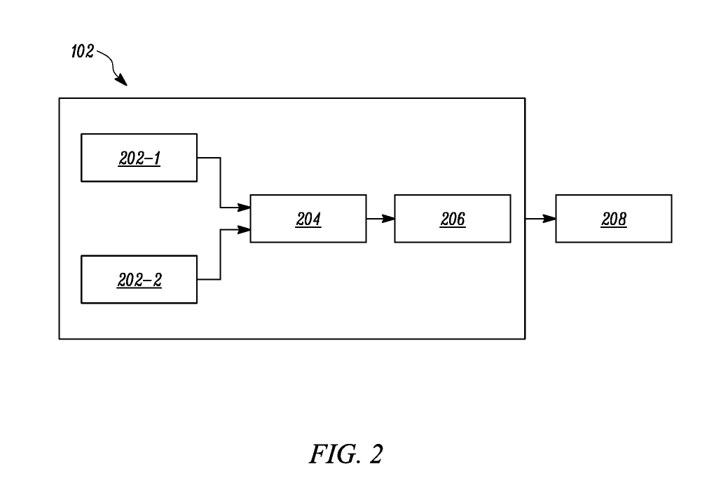

### DETAILED DESCRIPTION

Wherever possible, the same reference numbers will be used throughout the drawings to refer to the same or the like parts. FIG. 1 illustrates a schematic view of a train 100 in communication with a system 102 for identifying and predicting a fault in sensors 202 (shown in FIG. 2) disposed in two or more locomotives 104, according to one embodiment of the present disclosure. The train 100 includes two or more locomotives 104 forming a consist 108 for providing motive power for the train 100, two or more rail cars 106 for carrying passengers or goods, and a number of wheels 110 for moving the plurality of locomotives 104 and the rail cars 106 on railroad tracks 112. Referring to FIG. 1, the locomotives 104 may be individually referred to as a first locomotive 104-1, and a second locomotive 104-2. Similarly, the rail cars 106 may be individually referred to as a first rail car 106-1, a second rail car 106-2, a third rail car 106-3, and a fourth rail car 106-4.

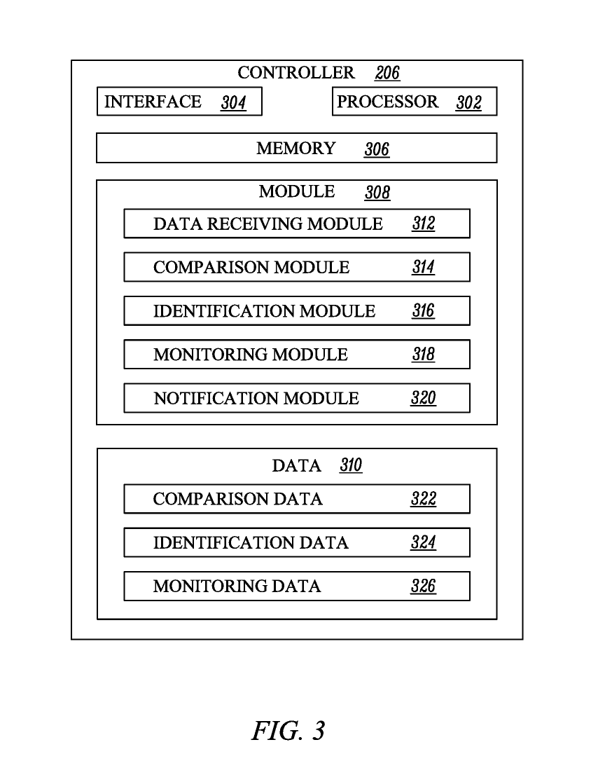

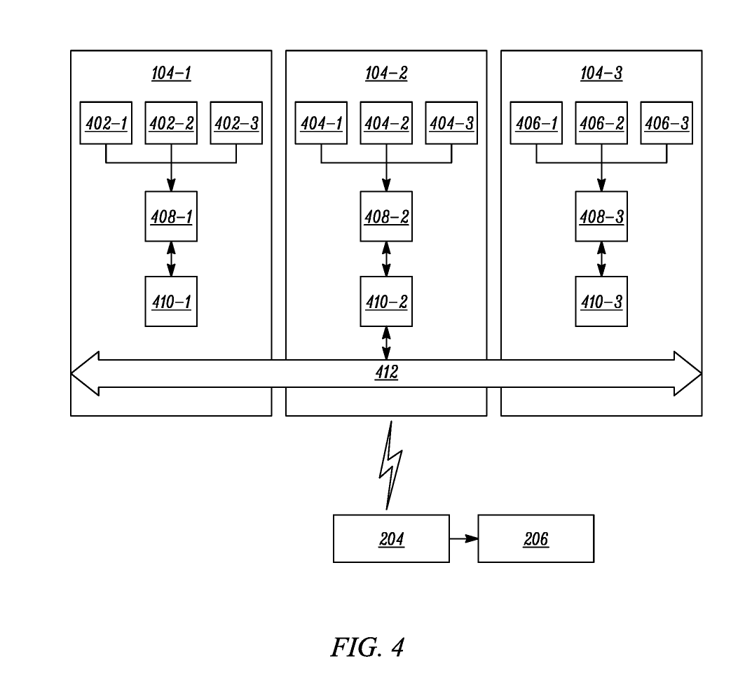

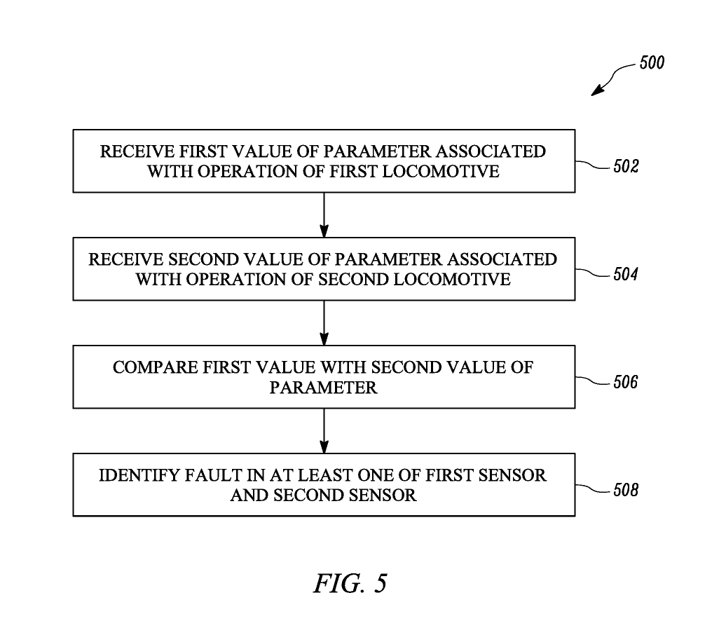

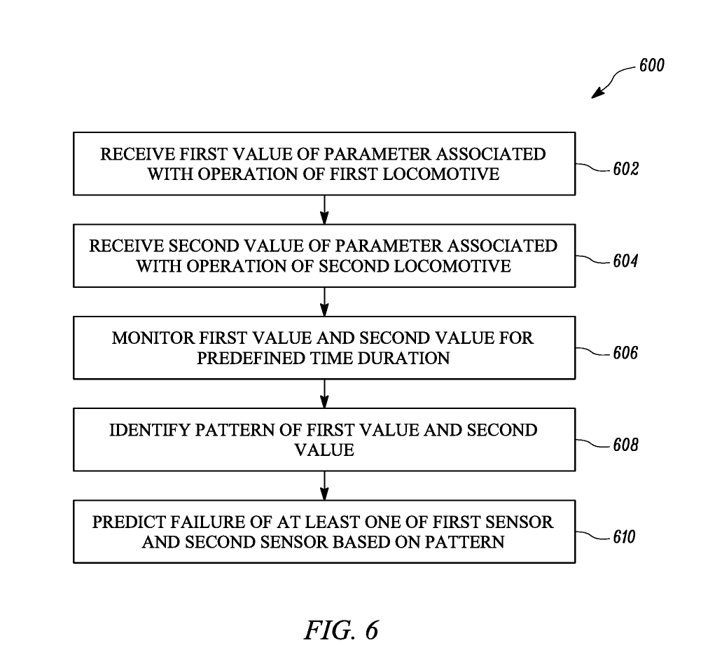

In particular, the system 102 is in communication with the locomotives 104 of the train 100. In FIG. 1, the consist 108 includes two locomotives 104, namely, the first locomotive 104-1 and the second locomotive 104-2. Therefore, in the present embodiment, the system 102 is explained with regard to the communication with the first locomotive 104-1 and the second locomotive 104-2. In other embodiments, the system 102 may be in communication with more than two locomotives 104 of the consist 108, without departing from the scope of the present disclosure. The constructional and operational details of the system 102 are explained in detail in the description of FIG. 2, FIG. 3, FIG. 4, FIG. 5, and FIG. 6.

In one embodiment, the first locomotive 104-1 and the second locomotive 104-2 may be one of a diesel-electric locomotive, a coal-electric locomotive, a gas-electric locomotive, and a hybrid locomotive with electric power sources known in the art. One or both of the first locomotive 104-1 and the second locomotive 104-2 may accommodate an operator in a first operator cabin 114-1 and a second operator cabin 114-2 respectively, collectively referred to as operator cabins 114, to control operations of the train 100 by using a number of control equipment (not shown). In an example, each of the first operator cabin 114-1 and the second operator cabin 114-2 may include an operator interface (not shown) having control levers, switches, and a display. In an example, the operator interface may allow the operator to control a movement of the train 100, and perform various operations of the train 100.

In one embodiment, the locomotives 104 are in communication with each other through a communication unit 116. In one embodiment, the communication unit 116 may enable the locomotives 104 to communicate with each other through a protocol overlay (not shown) and a multiple-unit train-line (not shown). In the present embodiment, the communication unit 116 may facilitate the locomotives 104 with train-line network equipment (not shown) to communicate with each other.

In one embodiment, the train 100 also includes a tender 118 positioned between the first locomotive 114-1 and the second locomotive 114-2. In an example, the tender 118 may be optionally located at various other positions relative to the first locomotive 114-1, for example, behind the second locomotive 114-2, depending on specific requirements of an application. The tender 118 may capture dynamic brake energy generated by the first locomotive 114-1 and the second locomotive 114-2. In some examples, the tender 118 may have powered axles (not shown) and traction motors (not shown).

FIG. 2 illustrates a block diagram of the system 102, according to one embodiment of the present disclosure. The system 102 includes a first sensor 202-1, a second sensor 202-2, a receiving unit 204 in communication with the first sensor 202-1 and the second sensor 202-2, and a controller 206 in communication with the receiving unit 204. In one embodiment, the first sensor 202-1 and the second sensor 202-2 are collectively referred to as sensors 202.

In the present embodiment, the first sensor 202-1 and the second sensor 202-2 are disposed in the first locomotive 104-1 and the second locomotive 104-2, respectively. The first sensor 202-1 is configured to detect a first value of a parameter associated with operation of the first locomotive 104-1. The second sensor 202-2 is configured to detect a second value of the parameter associated with operation of the second locomotive 104-2. In one embodiment, the parameter may be an ambient parameter. In such an embodiment, the parameter includes, but is not limited to, a temperature and a pressure of the first locomotive 104-1 and the second locomotive 104-2.

In one embodiment where the parameter to be detected is the temperature of the first locomotive 104-1 and the second locomotive 104-2, the first sensor 202-1 and the second sensor 202-2 may be temperature sensors disposed in the first locomotive 104-1 and the second locomotive 104-2, respectively. In an embodiment where the parameter to be detected is the pressure of the first locomotive 104-1 and the second locomotive 104-2, the first sensor 202-1 and the second sensor 202-2 may be pressure sensors disposed in the first locomotive 104-1 and the second locomotive 104-2, respectively.

In other embodiments, the sensors 202 may be non-ambient sensors, without departing from the scope of the present disclosure. In one embodiment, details pertaining to the parameters may be used for controlling engines (not shown) and the traction motors of the train 100.

The receiving unit 204 of the system 102 is configured to receive the first value and the second value from the first sensor 202-1 and the second sensor 202-2, respectively. In one embodiment, the receiving unit 204 may be disposed within one or more of the first locomotive 104-1, the second locomotive 104-2, the tender 118, and the rail cars 106. In other embodiments, the receiving unit 204 may be disposed at a remote location and may be in wireless communication with the first sensor 202-1, the second sensor 202-2, and the controller 206. The receiving unit 204 may forward the first value and the second value to the controller 206.

The controller 206 is configured to compare the first value and the second value, and identify and predict the fault in at least one of the first sensor 202-1 and the second sensor 202-2 based on the comparison between the first value and the second value. Once the controller 206 identifies or predicts the fault in at least one of the first sensor 202-1 and the second sensor 202-2, the controller 206 generates and forwards a notification to the operator through an output device 208. The constructional and operational details of the controller 206 are explained in detail in the description of FIG. 3.

The output device 208 may be one of an audio device, a video device, and an audio-video device disposed in the operator cabins 114 of one or both of the first locomotive 104-1 and the second locomotive 104-2. In one embodiment, the output device 208 may be disposed at a central station (not shown) in wireless communication with the system 102.

FIG. 3 illustrates a block diagram of the controller 206 of the system 102, according to one embodiment of the present disclosure. Referring to FIG. 2 and FIG. 3, the controller 206 may include a processor 302, an interface 304, and a memory 306 coupled to the processor 302. The processor 302 may be configured to fetch and execute computer readable instructions stored in the memory 306. In some embodiments, the processor 302 may be implemented as one or more microprocessors, microcomputers, microcontrollers, digital signal processors, central processing units, state machine, logic circuitries or any devices that manipulate signals based on operational instructions.

The interface 304 may facilitate multiple communications within wide variety of protocols and networks, including wired network. Further, the interface 304 may include a variety of software and hardware interfaces. In some embodiments, the interface 304 may include, but is not limited to, peripheral devices, such as a keyboard, a mouse, an external memory, and/or a printer. The interface 304 may facilitate multiple communications within wide variety of protocols and networks, including wired network. In one example, the interface 304 may include one or more ports for connecting the controller 206 to an output unit (not shown).

In some embodiments, the memory 306 may include any non-transitory computer-readable medium. In one example, the non-transitory computer-readable medium may be a volatile memory, such as static random access memory and a non-volatile memory, such as read-only memory, erasable programmable ROM, and flash memory.

The controller 206 may include modules 308 and data 310. The modules 308 may include hardware and/or software (routines, programs, objects, components, and data structures) which perform particular tasks or implement particular data types. In some embodiments, the modules 308 may include a data receiving module 312, a comparison module 314, an identification module 316, a monitoring module 318, and a notification module 320. The data 310 may be included in a repository for storing data processed, received, and generated by one or more of the modules 308. The data 310 may include a comparison data 322, an identification data 324, and a monitoring data 326.

In one embodiment, the data receiving module 312 may receive data pertaining to the first value and the second value of the parameter as detected by the first sensor 202-1 and the second sensor 202-2, respectively. In one embodiment, the data receiving module 312 may receive the first value and the second value directly from the first sensor 202-1 and the second sensor 202-2, respectively. In another embodiment, the data receiving module 312 may receive the first value and the second value from the receiving unit 204. In one embodiment, details pertaining to the data receiving module 312 may be stored in the comparison data 322.

Upon receiving the first value and the second value by the data receiving module 312, the comparison module 314 may compare the first value and the second value of the parameter with each other. Based on the comparison, the comparison module 314 may determine a variation between the first value and the second value. The comparison module 314 may then compare the variation with a predefined acceptable range of variation.

In one embodiment, the predefined acceptable range of variation may be stored for values of each parameter as detected by the first sensor 202-1 and the second sensor 202-2. In the present embodiment, a predefined acceptable range of variation may be stored for values of the temperature and the pressure of the first locomotive 104-1 and the second locomotive 104-2. In one embodiment, the predefined acceptable range of variation for each parameter may be stored by the operator. In another embodiment, the predefined acceptable range of variation for each parameter may be derived by the system 102 based on historical data of values of the parameters as detected by the first sensor 202-1 and the second sensor 202-2. In one embodiment, details pertaining to the comparison module 314 may be stored in the comparison data 322.

Based on the comparison between the first value and the second value, the identification module 316 may identify a fault in one of the first sensor 202-1 and the second sensor 202-2. The identification module 316 may identify the fault based on the variation between the first value and the second value, and the predefined acceptable range of variation corresponding to the first value and the second value of the parameter. In one embodiment, when the variation falls within the predefined acceptable range of variation, the identification module 316 may not identify the fault in one of the first sensor 202-1 and the second sensor 202-2. In an alternate embodiment, when the variation falls out of the predefined acceptable range of variation, the identification module 316 may identify the fault in one of the first sensor 202-1 and the second sensor 202-2. In one embodiment, details pertaining to the identification module 316 may be stored in the identification data 324.

In one example where the first sensor 202-1 and the second sensor 202-2 are temperature sensors for determining values of the temperature for the first locomotive 104-1 and the second locomotive 104-2, the first sensor 202-1 and the second sensor 202-2 may detect the first value and the second value as “23° C.” and “25° C.”. In such an example, the comparison module 314 may determine the variation as “2° C.”. Considering that the first value and the second value should ideally be same as a geographic location of the first locomotive 104-1 and the second locomotive 104-2 is same, the predefined acceptable range of variation may be defined as “1° C.”. Therefore, in the present example, the identification module 316 may identify a fault in one of the first sensor 202-1 and the second sensor 202-2 as the variation “2° C.” falls out of the predefined acceptable range of variation, i.e., “1° C.”

Further, once the identification module 316 identifies the fault in one or more of the first sensor 202-1 and the second sensor 202-2, the system 102 may reject values detected by the faulty sensor 202 for further processing and analysis unless the faulty sensor 202 is fixed or replaced with a new sensor 202.

In one embodiment, the monitoring module 318 may monitor the first value and the second value as detected by the first sensor 202-1 and the second sensor 202-2 for a predefined time duration. Based on the monitoring, the monitoring module 318 may then identify a pattern as shown by the first value and the second value over the predefined time duration. The pattern may be understood as a trend followed by the first value and the second value of the parameter detected by the first sensor 202-1 or the second sensor 202-2 respectively, over the predefined time duration.

The monitoring module 318 may predict the fault in at least one of the first sensor 202-1 and the second sensor 202-2 based on the pattern followed by the first value and the second value over the predefined time duration. In particular, the monitoring module 318 may predict the fault in at least one of the first sensor 202-1 and the second sensor 202-2 based on a pattern of the variation between the first value and the second value determined over the predefined time duration. In such an embodiment, the monitoring module 318 may determine the pattern based on the variation as determined by the comparison module 314. In one embodiment, details pertaining to the monitoring module 318 may be stored in the monitoring data 326.

In one example where the first sensor 202-1 and the second sensor 202-2 are temperature sensors for determining values of the temperature parameter for the first locomotive 104-1 and the second locomotive 104-2, the comparison module 314 may determine a variation of “1° C.”, “1.2° C.”, “1.35° C.”, “1.55° C.”, “1.6° C.”, “1.7° C.”, and “1.75° C.” over a predefined time duration of 7 days. If a predefined acceptable range of variation for the present example is “2° C.”, the monitoring module 318 may predict the fault in one of the first sensor 202-1 and the second sensor 202-2 as the variation is approaching a threshold value of the predefined acceptable range of variation, i.e., “2° C.”

Once the identification module 316 identifies the fault or the monitoring module 318 predicts the fault in at least one of the first sensor 202-1 and the second sensor 202-2, the notification module 320 may generate a notification. In case the identification module 316 has identified the fault in one of the first sensor 202-1 and the second sensor 202-2, the notification module 320 may generate a notification indicative of the fault. In one example, the notification may instruct the operator to fix the fault in the faulty sensor 202. In case the monitoring module 318 has predicted the fault in at least one of the first sensor 202-1 and the second sensor 202-2, the notification module 320 may generate a notification indicative of the fault. In one example, the notification may instruct the operator to either fix the faulty sensor 202 or replace the faulty sensor 202 well in time.

In one embodiment, the notification module 320 may generate the notification based on a criticality of the fault in the first sensor 202-1 and the second sensor 202-2. In one embodiment, the system 102 may assign a criticality level to each type of fault that can be identified or predicted for the first sensor 202-1 and the second sensor 202-2. In one example, when the fault is such that it may lead to an immediate failure of at least one of the first sensor 202-1 and the second sensor 202-2, the system 102 may assign a criticality level as “High” for such a fault. In case of identification of such a fault by the identification module 316, the notification module 320 may raise a specific alarm indicative of the high criticality of the fault. For example, in case of identification of a high criticality fault, the notification module 320 may generate a visual as well as audio notification to attract an immediate attention of the operator. Similarly, in case of identification of a low criticality fault, the notification module 320 may only generate a visual notification.

In one embodiment, the notification module 320 may generate a periodic report, also referred to as report, indicative of the notifications or alarms generated during a predefined duration. The report may include, but is not limited to, detected faults, predicted faults, a criticality of the faults, an action suggested to mitigate the fault, and an action taken to address the fault. The notification module 320 may forward the notification and the report to the output device 208 for the operator. In one embodiment, details pertaining to the notification module 320 may be stored in the identification data 324. In another embodiment, details pertaining to the notification module 320 may be stored in the monitoring data 326.

FIG. 4 illustrates a block diagram of the locomotives 104 in communication with the system 102, according to another embodiment of the present disclosure. In the present embodiment, the train 100 includes three locomotives 104, individually referred to as the first locomotive 104-1, the second locomotive 104-2, and a third locomotive 104-3. Each of the first locomotive 104-2, the second locomotive 104-2, and the third locomotive 104-3 includes three sensors. The first locomotive 104-1 may include a first sensor 402-1, a second sensor 402-2, and a third sensor 402-3, collectively referred to as sensors 402. The second locomotive 104-2 may include a fourth sensor 404-1, a fifth sensor 404-2, and a sixth sensor 404-3, collectively referred to as sensors 404. The third locomotive 104-3 may include a seventh sensor 406-1, an eighth sensor 406-2, and a ninth sensor 406-3, collectively referred to as sensors 406.

In the present embodiment, the first sensor 402-1, the fourth sensor 404-1, and the seventh sensor 406-1 may detect values of a first parameter of the first locomotive 104-1, the second locomotive 104-2, and the third locomotive 104-3, respectively. Further, the second sensor 402-2, the fifth sensor 404-2, and the eighth sensor 406-2 may detect values of a second parameter of the first locomotive 104-1, the second locomotive 104-2, and the third locomotive 104-3, respectively. Furthermore, the third sensor 402-3, the sixth sensor 404-3, and the ninth sensor 406-3 may detect values of a third parameter of the first locomotive 104-1, the second locomotive 104-2, and the third locomotive 104-3, respectively.

The values as detected by the sensors 402 may be forwarded to a first controller 408-1 disposed in the first locomotive 104-1. The values as detected by the sensors 404 may be forwarded to a second controller 408-2 disposed in the second locomotive 104-2. The values as detected by the sensors 406 may be forwarded to a third controller 408-3 disposed in the third locomotive 104-3. The first controller 408-1, the second controller 408-2, and the third controller 408-3 may be collectively referred to as controllers 408 of the locomotives 104. In one embodiment, the first controller 408-1, the second controller 408-2, and the third controller 408-3 may be microcontrollers in communication with the sensors 402, 404, and 406 of the first locomotive 104-1, the second locomotive 104-2, and the third locomotive 104-3, respectively.

Further, the first locomotive 104-1, the second locomotive 104-2, and the third locomotive 104-3 may include a first train-line network router 410-1, a second train-line network router 410-2, and a third train-line network router 410-3 as part of the communication unit 116. The first train-line network router 410-1, the second train-line network router 410-2, and the third train-line network router 410-3 may be collectively referred to as train-line network routers 410. In the present embodiment, the communication unit 116 also includes a train-line network 412. Through the train-line network routers 410, the locomotives 104 may be connected to the train-line network 412 to communicate with each other.

In one embodiment, the locomotives 104 may be connected to the receiving unit 204 and the controller 206 of the system 102 through the communication unit 116 for identification and prediction of the fault in the sensors 402, 404, and 406. The receiving unit 204 and the controller 206 may then operate as explained in the description of FIG. 1, FIG. 2, and FIG. 3. In another embodiment, one or more of the controllers 408 of the locomotives 104 may operate as the controller 206 of the system 102, without departing from the scope of the present disclosure.

### INDUSTRIAL APPLICABILITY

The present disclosure relates to the system 102 and methods 500 and 600 for identifying and predicting the fault in the sensors 202 disposed in the locomotives 104 of the consist 108. The system 102 of the present disclosure can be implemented for identifying faults in any number of the sensors 202 of any number of locomotives 104 of the consist 108. In one embodiment, the system 102 may include the controller 206 which can be disposed either onboard or off-board the train 100. In another embodiment, the controllers 408 of the locomotives 104 may act as the controller 206 of the system 102 for identifying and predicting the fault in the sensors 202. Further, the receiving unit 204 of the system 102 may also be disposed either onboard or off-board the train 100.

Although the present disclosure is explained with regard to the sensors 202 of the locomotives 104 of the consist 108, the system 102 and the methods 500 and 600 may be equally applicable for identifying and predicting the faults of the sensors 202 disposed in any equipment provided the sensors 202 are at the same geographic location, without departing from the scope of the present disclosure. Therefore, the system 102 and the methods 500 and 600 of the present disclosure have a wide variety of applications across various industries.

FIG. 5 illustrates a flowchart of the method 500 for identifying the fault in the sensors 202 disposed in two or more locomotives 104 of the consist 108, according to one embodiment of the present disclosure. For the sake of brevity, some aspects of the present disclosure which are already explained in detail in the description of FIG. 1, FIG. 2, FIG. 3, and FIG. 4 are not explained in the description of FIG. 5.

At block 502, the method 500 includes receiving the first value of the parameter associated with operation of the first locomotive 104-1. In one embodiment, the first value of the parameter may be received from the first sensor 202-1. The parameter includes, but is not limited to, the temperature and a barometric pressure of the locomotives 104. In one embodiment, the receiving unit 204 of the system 102 may receive the first value of the parameter. In one embodiment, the data receiving module 312 of the controller 206 of the system 102 may receive the first value of the parameter.

At block 504, the method 500 includes receiving the second value of the parameter associated with operation of the second locomotive 104-2. In one embodiment, the second value of the parameter may be received from the second sensor 202-2. In one embodiment, the receiving unit 204 of the system 102 may receive the second value of the parameter. In one embodiment, the data receiving module 312 of the controller 206 of the system 102 may receive the second value of the parameter.

At block 506, the method 500 includes comparing the first value with the second value of the parameter. In one embodiment, the comparison module 314 of the controller 206 of the system 102 may compare the first value with the second value.

At block 508, the method 500 includes identifying the fault in at least one of the first sensor 202-1 and the second sensor 202-2 based on the comparison between the first value and the second value. In one embodiment, the fault is identified based on variation between the first value and the second value, and the predefined acceptable range of variation. Further, the method 500 includes generating the notification based on the identification of the fault. In one embodiment, the identification module 316 of the controller 206 of the system 102 may identify the fault in at least one of the first sensor 202-1 and the second sensor 202-2.

In one embodiment, the method 500 includes monitoring the first value and the second value received from the first sensor 202-1 and the second sensor 202-2 respectively, for the predefined time duration. The method 500 further includes identifying the pattern of the first value and the second value of the parameter over the predefined time duration. The method 500 then includes predicting the fault in at least one of the first sensor 202-1 and the second sensor 202-2 based on the pattern of the first value and the second value.

FIG. 6 illustrates a flowchart of the method 600 for predicting the fault in the sensors 202 disposed in the two or more locomotives 104 of the consist 108, according to one embodiment of the present disclosure. For the sake of brevity, some aspects of the present disclosure which are already explained in detail in the description of FIG. 1, FIG. 2, FIG. 3, FIG. 4, and FIG. 5 are not explained in the description of FIG. 6.

At block 602, the method 600 includes receiving the first value of the parameter associated with the operation of the first locomotive 104-1. In one embodiment, the first value may be received from the first sensor 202-1. The parameter includes at least one of the temperature and the pressure of the locomotives 104. In one embodiment, the receiving unit 204 of the system 102 may receive the first value of the parameter. In one embodiment, the data receiving module 312 of the controller 206 of the system 102 may receive the first value of the parameter.

At block 604, the method 600 includes receiving the second value of the parameter associated with the operation of the second locomotive 104-2. In one embodiment, the second value may be received from the second sensor 202-2. In one embodiment, the receiving unit 204 of the system 102 may receive the second value of the parameter. In one embodiment, the data receiving module 312 of the controller 206 of the system 102 may receive the second value of the parameter.

At block 606, the method 600 includes monitoring the first value and the second value received from the first sensor 202-1 and the second sensor 202-2 respectively, for the predefined time duration. In one embodiment, the monitoring module 318 of the controller 206 of the system 102 may monitor the first value and the second value for the predefined time duration.

At block 608, the method 600 includes identifying the pattern of the first value and the second value of the parameter over the predefined time duration. In one embodiment, the monitoring module 318 of the controller 206 of the system 102 may identify the pattern of the first value and the second value.

At block 610, the method 600 includes predicting the fault in at least one of the first sensor 202-1 and the second sensor 202-2 based on the pattern of the first value and the second value. The method 600 further includes generating the notification based on the prediction of the fault. The notification may be indicative of the fault in at least one of the first sensor 202-1 and the second sensor 202-2. In one embodiment, the monitoring module 318 of the controller 206 of the system 102 may predict the fault in at least one of the first sensor 202-1 and the second sensor 202-2.

The method 600 includes comparing the first value with the second value of the parameter. The method 600 further includes identifying the fault in at least one of the first sensor 202-1 and the second sensor 202-2 based on the comparison between the first value and the second value. The fault is identified based on the variation between the first value and the second value, and the predefined acceptable range of variation.

The system 102 and the methods 500 and 600 of the present disclosure offer a comprehensive approach for identifying and predicting faults of the sensors 202 of the locomotives 104 of the consist 108. The system 102 may be implemented for the locomotives 104 without making any changes in the already existing construction of the locomotives 104. Further, the already existing controllers 408 of the locomotives 104 may operate as the controller 206 of the system 102. The present disclosure allows an exchange of data pertaining to the sensors 202 between the locomotives 104. Also, the receiving unit 204 and the controller 206 may be disposed onboard as well as off-board the train 100. Therefore, the system 102 offers flexibility in terms of embodiment. This in turn would result into a significant reduction in the cost associated with installing, operation, and maintenance of the system 102 for identifying and predicting faults of the sensors 202 in the locomotives 104.

Moreover, as the system 102 and the method 500 and 600 ensure a timely awareness about a failure or a defect of the sensors 202, any damage to the locomotives 104 and the passengers may be avoided well in time. Also, since the system 102 ensures that the locomotives 104 are not operating based on the faulty sensors 202, an overall efficiency of the operation of the locomotives 104 may be significantly improved. Therefore, the present disclosure offers the system 102 and the methods 500 and 600 for identifying and predicting the faults in the sensors 202 that are simple, effective, economical, flexible, and time saving.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for identifying a fault in sensors disposed in two or more locomotives of a consist, the system comprising:
a first sensor, disposed in a first locomotive, configured to detect a first value of a parameter associated with operation of the first locomotive;
a second sensor, disposed in a second locomotive in communication with the first locomotive, configured to detect a second value of the parameter associated with operation of the second locomotive;
a receiving unit, in communication with the first sensor and the second sensor, configured to receive the first value and the second value of the parameter from the first sensor and the second sensor respectively;
and
a controller, in communication with the receiving unit, configured to:
compare the first value with the second value of the parameter; and
identify the fault in one of the first sensor and the second sensor based on the comparison between the first value and the second value.

2. The system of claim 1, wherein the controller is configured to identify the fault based on a variation between the first value and the second value, and a predefined acceptable range of the variation.

3. The system of claim 1, wherein the controller is configured to generate a notification based on the identification of the fault.

4. The system of claim 1, wherein the controller is configured to:
monitor the first value and the second value received from the first sensor and the second sensor respectively, for a predefined time duration; and
identify a pattern of the first value and the second value of the parameter over the predefined time duration.

5. The system of claim 4, wherein the controller is configured to predict the fault in at least one of the first sensor and the second sensor based on the pattern of the first value and the second value.

6. The system of claim 1, wherein the parameter includes at least one of a temperature and a pressure of the first locomotive and the second locomotive.

7. A method for identifying a fault in sensors disposed in two or more locomotives of a consist, the method comprising:
receiving, from a first sensor, a first value of a parameter associated with operation of a first locomotive;
receiving, from a second sensor, a second value of the parameter associated with operation of a second locomotive;
comparing the first value with the second value of the parameter; and
identifying the fault in at least one of the first sensor and the second sensor based on the comparison between the first value and the second value.

8. The method of claim 7, wherein the fault is identified based on a variation between the first value and the second value, and a predefined acceptable range of the variation.

9. The method of claim 7 further comprising, generating a notification based on the identification of the fault.

10. The method of claim 7 further comprising:
monitoring the first value and the second value received from the first sensor and the second sensor respectively, for a predefined time duration; and
identifying a pattern of the first value and the second value of the parameter over the predefined time duration.

11. The method of claim 10 further comprising, predicting the fault in at least one of the first sensor and the second sensor based on the pattern of the first value and the second value.

12. The method of claim 7, wherein the parameter includes at least one of a temperature and a pressure of the first locomotive and the second locomotive.

13. A method for predicting a fault in sensors disposed in two or more locomotives of a consist, the method comprising:
receiving, from a first sensor, a first value of a parameter associated with operation of a first locomotive;
receiving, from a second sensor, a second value of the parameter associated with operation of a second locomotive;
monitoring the first value and the second value received from the first sensor and the second sensor respectively, for a predefined time duration;
identifying a pattern of the first value and the second value of the parameter over the predefined time duration; and
predicting the fault in at least one of the first sensor and the second sensor based on the pattern of the first value and the second value.

14. The method of claim 13 further comprising, generating a notification based on the prediction of the fault in at least one of the first sensor and the second sensor.

15. The method of claim 13, wherein the parameter includes at least one of a temperature and a pressure of the first locomotive and the second locomotive.

16. The method of claim 13 further comprising:
comparing the first value with the second value of the parameter; and
identifying the fault in at least one of the first sensor and the second sensor based on the comparison between the first value and the second value.

17. The method of claim 16, wherein the fault is identified based on a variation between the first value and the second value, and a predefined acceptable range of the variation.
